(19) United States
(12) Patent Application Publication
(10) Pub. No.: US 2015/0283025 A1
(43) Pub. Date: Oct. 8, 2015

(54) PORTABLE MASSAGE, MAGNET AND LIGHT THERAPY DEVICE

(71) Applicant: Ori Ledany, Las Vegas, NV (US)

(72) Inventor: Ori Ledany, Las Vegas, NV (US)

(21) Appl. No.: 14/681,871

(22) Filed: Apr. 8, 2015

Related U.S. Application Data
(60) Provisional application No. 61/976,857, filed on Apr. 8, 2014.

(51) Int. Cl. A61H 23/00

(52) U.S. Cl. CPC A61H 23/00; A61H 2205/02; A61H 2201/10

(57) ABSTRACT

A portable massage, magnet and light therapy device including a body portion, a head portion, a plurality of magnets, a vibrating mechanism and a power mechanism. The head portion is attachable to an end of the body portion. The plurality of magnets is mounted to at least one of the body portion and the head portion. The plurality of LEDs is mounted to at least one of the body portion and the head portion. The vibrating mechanism is mounted to at least one of the body portion and the head portion. The power mechanism is operably attached to the plurality of LEDs and the vibrating mechanism.

### FIELD OF THE INVENTION

This application claims priority to U.S. Provisional Application No. 61/976,857, which was filed on Apr. 8, 2014, the contents of which are incorporated herein by reference.

### FIELD OF THE INVENTION

The invention relates to devices for treating soft tissue ailments of in a human body. More particularly, the invention relates to a portable massage, magnet and light therapy device.

### BACKGROUND OF THE INVENTION

It is known that massage therapy devices may be used to treat pain and aches of soft tissue to ease the physical ailments in a human body. One such portable massage therapy device is disclosed in Ledany, U.S. Pat. No. 5,918,601.

### SUMMARY OF THE INVENTION

An embodiment of the invention is directed to a portable massage, magnet and light therapy device that includes a body portion, a head portion, interchangeable heads option, a plurality of magnets, a vibrating mechanism and a power mechanism. The head portion is attachable to an end of the body portion. The plurality of magnets is mounted to at least one of the body portion and the head portion. The plurality of LEDs is mounted to at least one of the body portion and the head portion. The vibrating mechanism is mounted to at least one of the body portion and the head portion. The power mechanism is operably attached to the plurality of LEDs and the vibrating mechanism.

Another embodiment of the invention is directed to a portable massage, magnet and light therapy device that includes a body portion, a head portion, a plurality of magnets, a plurality of LEDs, a vibrating mechanism and a power mechanism. The head portion is attachable to an end of the body portion. The plurality of magnets are mounted to at least one of the body portion and the head portion. The plurality of LEDs are mounted to at least one of the body portion and the head portion. The vibrating mechanism is mounted to at least one of the body portion and the head portion. The power mechanism is operably attached to the plurality of LEDs and the vibrating mechanism. The resilient cover extends over at least a portion of the body portion.

Another embodiment of the invention is directed to a portable massage, magnet and light therapy device that includes a body portion, a head portion, a plurality of magnets, a plurality of LEDs, a vibrating mechanism and a power mechanism. The head portion is attachable to an end of the body portion. The plurality of magnets are mounted to at least one of the body portion and the head portion. The plurality of LEDs are mounted to at least one of the body portion and the head portion. The plurality of LEDs include a first group of LEDs and a second group of LEDs. The first group of LEDs emitting light at a different wavelength than the second group of LEDs. The vibrating mechanism is mounted to at least one of the body portion and the head portion. The power mechanism is operably attached to the plurality of LEDs and the vibrating mechanism.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a portable massage, magnet and light therapy device according to an embodiment of the invention.

FIG. 2 is a side view of the portable massage, magnet and light therapy device.

FIG. 3 is an exploded side view of the portable massage, magnet and light therapy device.

FIG. 4 is a sectional view of the portable massage, magnet and light therapy device in an assembled configuration.

FIG. 5 is a sectional view of the portable massage, magnet and light therapy device with an end cap partially inserted.

FIG. 6 is an end view of an embodiment of a head portion of the portable massage, magnet and light therapy device.

FIG. 7 is an end view of an alternative configuration of the head portion of the portable massage, magnet and light therapy device.

FIG. 8 is an end view of a bottom cap portion of the portable massage, magnet and light therapy device.

FIG. 9 is a perspective view of a cosmetic cap for use in conjunction with the portable, massage, magnet and light therapy device.

FIG. 10 is a side view of the cosmetic cap of FIG. 9.

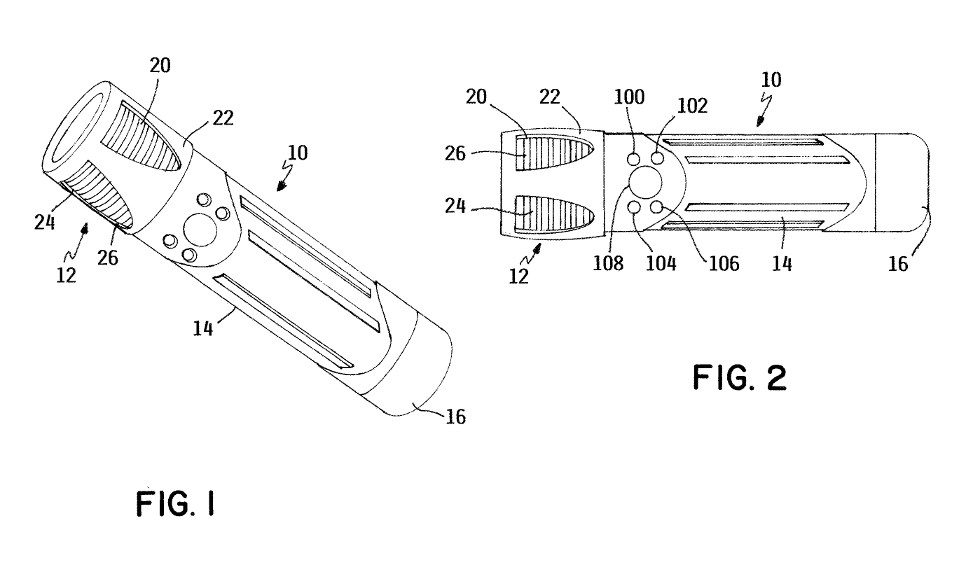

### DETAILED DESCRIPTION OF THE PREFERRED EMBODIMENTS

An embodiment of the invention is directed to a portable massage, magnet and light therapy device 10 that includes three main components a head portion 12, a body portion 14 and a bottom cap portion 16, as illustrated in the Figures.

In certain embodiments, a length of the portable massage, magnet and light therapy device 10 may be about 6 3/4 inches. In certain embodiments, the head portion 12 and the body portion 14 may have a diameter of about 2 inches. In certain embodiments, the bottom cap portion 16 may have a diameter of about 1 5/8 inches.

The head portion 12 may be removably attached to the body portion 14 with a thread mechanism. The head portion 12 may have a plurality of grooves 20 formed in an outer surface thereof.

At least a portion of a head cover 22 may be placed over the head portion 12. The head cover 22 may have at least one opening 26 formed therein. The opening 26 enables the areas of the head portion 12 that are beneath to be seen. Such a configuration may facilitate obtaining a massaging action by contact with the grooves 20 on the head portion 12.

The head cover 22 may be fabricated of soft plastic/rubber that is similar to the soft plastic material that is used on a toothbrush handle. The soft plastic material may create resistive friction.

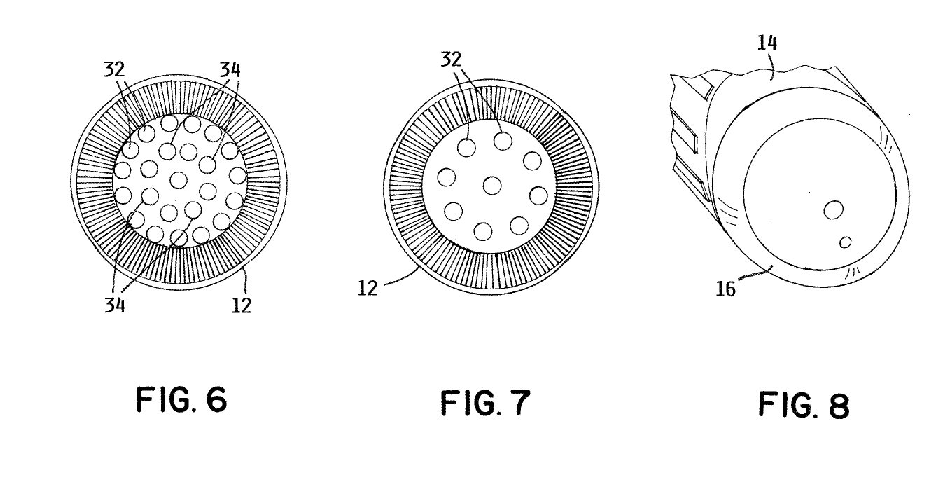

An upper surface of the head cover 22, which is opposite the body portion 14, may have a plurality of grooves 24 formed therein, as illustrated in FIGS. 6 and 7. The grooves 24 may enhance the vibrating action of the device 10.

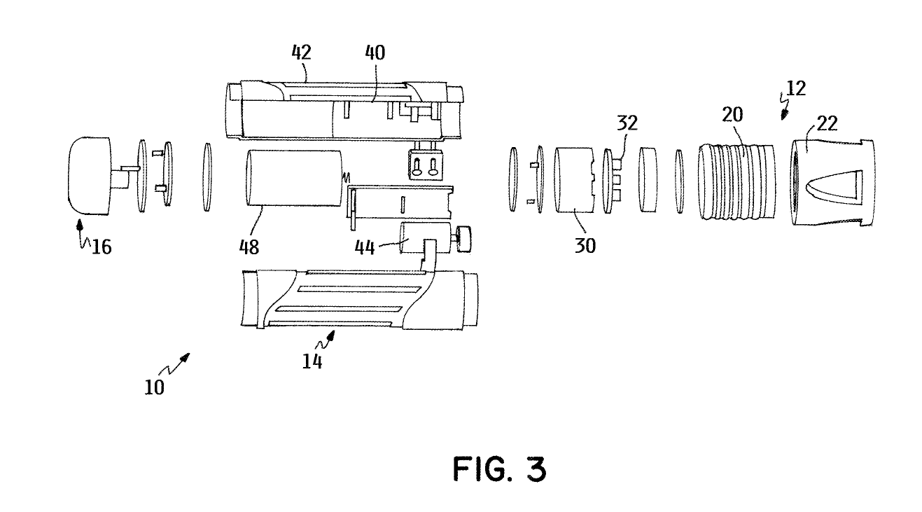

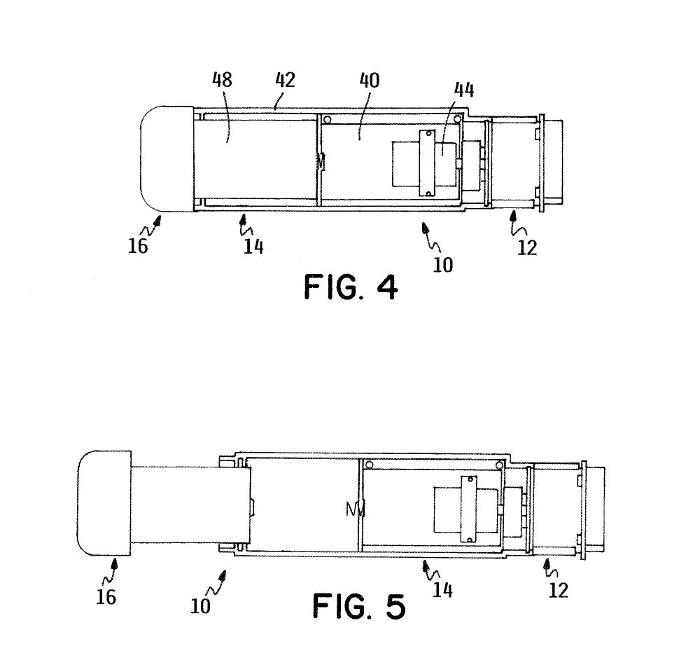

Inside the head portion 12 a plurality of magnets 30 are provided, as illustrated in FIG. 3. In certain embodiments, the magnets 30 may be arranged in 6 columns of 6 magnets each totaling 36 magnets. The total strength of the magnets 30 may be about 4,000 gauss. The arrangement of the magnets 30 in the head portion 12 may leave a space in the middle thereof where the lights may be placed.

In one configuration illustrated in FIG. 6, the head portion 12 includes 20 red LEDs 32 having a wavelength of about 660 nm and 4 blue LEDs 34 having a wavelength of about 440 nm. In another configuration illustrated in FIG. 7, the head portion 12 includes 9 blue LEDs 34 having a wavelength of about 440 nm. The base and round sidewall of the light should be chromium nickel for better reflection.

The body portion 14 may be formed with a substantially cylindrical shape. Proximate opposite ends of the body portion 14, a neck may be provided to facilitate attaching the head portion 12 and the bottom cap portion 16 to the body portion 14.

The neck proximate the top of the body portion 14 has threads formed therein to facilitate engaging the head portion 12. The neck proximate the bottom of the body portion 14 has threads formed therein to facilitate engaging the bottom cap portion 16.

Inside the body portion 14 two chambers 40, 42 may be provided. A top chamber 40 may have an electric motor 44 and a vibrating ball mounted therein. The motor base/holders may have a thin rubber design or any spongy material between them and the motor 44 to prevent unnecessary noise and enhance comfort when holding the portable massage, magnet and light therapy device 10.

Beneath the top chamber 40 is the second chamber 42 where the batteries 48 may be placed. In certain embodiments, the portable massage, magnet and light therapy device 10 may be powered using four AA rechargeable batteries. The batteries 48 should be sufficiently strong enough to power the operation of the motor 44 and the LED lights 32, 34 at the same time.

A spongy cover may be placed at least partially over the body portion 14. The cover should fit tightly on the body portion 14 while permitting the body portion 12 to slide out for cleaning purposes. An outer surface of the spongy cover may have a plurality of grooves formed therein to facilitate holding the portable massage, magnet and light therapy device 10.

The bottom cap portion 16 may serve two roles holding the batteries 48 and may include at least one aperture that enables the portable massage, magnet and light therapy device 10 to be connected to a charger. Alternatively, controls for the operation of the portable massage, magnet and light therapy device 10 may be positioned on a side surface of the device.

The bottom cap portion 16 may be fabricated from strong and flexible plastic to prevent cracks or breaks in the event the portable massage, magnet and light therapy device 10 falls on a hard surface.

In certain embodiments, the portable massage, magnet and light therapy device 10 includes a vibration power button 100, a vibration speed control button 102, a vibration speed display 108, an illumination power button 104 and an illumination mode control button 106. The control buttons may be recessed to facilitate a person accurately identifying a location of the control buttons without the need to look at the control buttons.

Pressing the vibration power button 100 causes the vibration system to turn on/off. Pressing the vibration speed control button 102 causes the vibration speed to change and such changed speed is displayed in the vibration speed display 108 Alternatively, it is possible to combine the vibration power button 100 and the vibration speed control button 102.

Pressing the illumination power button 104 causes the illumination system to turn on/off. Pressing the illumination mode control button 106 causes the illumination mode to change between always on and at least one flickering pattern. Alternatively, it is possible to combine the illumination power button 104 and the illumination mode control button 106.

A storage container (not shown) may be provided for use with the portable massage, magnet and light therapy device 10. The storage container may include a base portion and a lid portion that are operably attached to each other. To facilitate organization of the components, the storage container may have a plurality of recesses formed therein that are each adapted to partially receive one of the components.

To facilitate recharging the batteries, a charging base may be provided. The charging base may have a recess formed therein that is adapted to receive a portion of the portable massage, magnet and light therapy device 10.

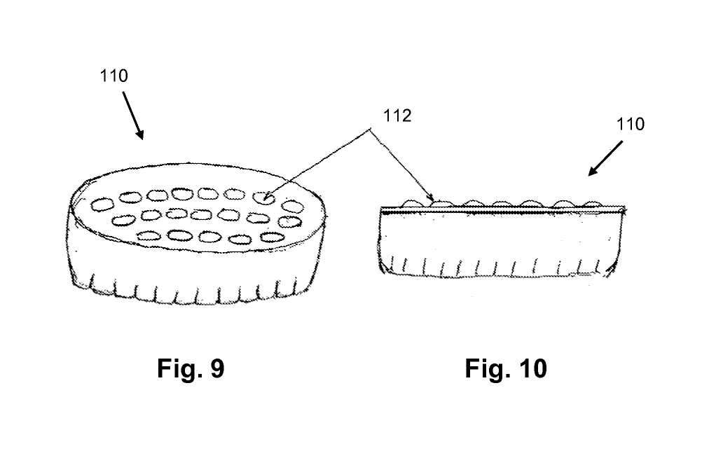

It is also possible to use a cosmetic cap 110 (such as is illustrated in FIGS. 9 and 10) in conjunction with the portable massage, magnet and light therapy device 10. The cosmetic cap 110 may be attached to the head cover 22 to facilitate use of the portable massage, magnet and light therapy device 10 with the cosmetic cap 110 attached thereto.

In certain embodiments, the cosmetic cap 110 is removably attached to the portable massage, magnet and light therapy device 10. A person of skill in the art will appreciate that a variety of techniques may be used to attach the cosmetic cap 110 to the portable massage, magnet and light therapy device 10.

At least a portion of the cosmetic cap 110 may be fabricated from a transparent or opaque material so that light emitted from the LED lights 32, 34 passes through the cosmetic cap 110. In certain embodiments, substantially all of the cosmetic cap 110 is fabricated from a transparent material.

An upper surface of the cosmetic cap 110 may include a plurality of magnifying bubbles 112 that increase the power of the LED lights 32, 34. The magnifying bubbles 112 may extend above a surface of the cosmetic cap 110 as illustrated in FIG. 10. This configuration may enable the magnifying bubbles 112 to provide a massaging action as the portable massage, magnet and light therapy device 10 is moved over the user's skin.

The upper surface of the cosmetic cap 110 may have a slightly concave shape. This configuration enables a user to place a cosmetic preparation such as skin cream in the concave region. The concave region thereby enhances the ability of the cosmetic preparation to remain in the cosmetic cap 110 as the cosmetic cap 110 is moved over the user's skin. The cosmetic cap 110 thereby enhances the ability that the cosmetic preparation will be massaged into the user's skin

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A portable massage, magnet and light therapy device comprising:
a body portion;
a head portion that is attachable to an end of the body portion;
a plurality of magnets mounted to at least one of the body portion and the head portion;
a plurality of LEDs mounted to at least one of the body portion and the head portion;
a vibrating mechanism mounted to at least one of the body portion and the head portion; and
a power mechanism that is operably attached to the plurality of LEDs and the vibrating mechanism.

2. The portable massage, magnet and light therapy device of claim 1, wherein the body portion has a cylindrical shape.

3. The portable massage, magnet and light therapy device of claim 1, and further comprising a resilient cover that extends over at least a portion of the body portion.

4. The portable massage, magnet and light therapy device of claim 1, wherein the head portion is removably attached to the body portion.

5. The portable massage, magnet and light therapy device of claim 1, wherein the head portion is attached to the body portion with a thread mechanism.

6. The portable massage, magnet and light therapy device of claim 1, and further comprising a switch mechanism that is capable of controlling the operation of at least one of the plurality of LEDs and the vibrating mechanism.

7. The portable massage, magnet and light therapy device of claim 1, wherein the head portion has a plurality of grooves formed in an outer surface thereof.

8. The portable massage, magnet and light therapy device of claim 1, and further comprising a head cover that extends over at least part of the head portion.

9. The portable massage, magnet and light therapy device of claim 8, wherein the head cover has a plurality of openings formed therein through which the head portion is visible.

10. The portable massage, magnet and light therapy device of claim 8, wherein an end of the head cover that is opposite the body portion has a plurality of grooves formed therein.

11. The portable massage, magnet and light therapy device of claim 1, wherein the magnets have a total strength of about 4,000 gauss and wherein the magnets are arrange in a circular configuration.

12. The portable massage, magnet and light therapy device of claim 1, wherein the plurality of LEDs comprises a first group of LEDs and a second group of LEDs, wherein the first group of LEDs emit light at a different wavelength than the second group of LEDs.

13. The portable massage, magnet and light therapy device of claim 12, wherein the first group of LEDs are capable of emitting light at a wavelength of about 660 nm and wherein the second group of LEDs are capable of emitting light at a wavelength of about 440 nm.

14. A portable massage, magnet and light therapy device comprising:
a body portion;
a head portion that is attachable to an end of the body portion;
a plurality of magnets mounted to at least one of the body portion and the head portion;
a plurality of LEDs mounted to at least one of the body portion and the head portion;
a vibrating mechanism mounted to at least one of the body portion and the head portion;
a power mechanism that is operably attached to the plurality of LEDs and the vibrating mechanism; and
a resilient cover that extends over at least a portion of the body portion.

15. The portable massage, magnet and light therapy device of claim 14, wherein the head portion is removably attached to the body portion with a thread mechanism, wherein the head portion has a plurality of grooves formed in an outer surface thereof and wherein the portable massage, magnet and light therapy device further comprises a switch mechanism that is capable of controlling the operation of at least one of the plurality of LEDs and the vibrating mechanism.

16. The portable massage, magnet and light therapy device of claim 14, and further comprising a head cover that extends over at least part of the head portion, wherein the head cover has a plurality of openings formed therein through which the head portion is visible, wherein an end of the head cover that is opposite the body portion has a plurality of grooves formed therein and wherein the magnets have a total strength of about 4,000 gauss and wherein the magnets are arrange in a circular configuration.

17. The portable massage, magnet and light therapy device of claim 14, wherein the plurality of LEDs comprises a first group of LEDs and a second group of LEDs, wherein the first group of LEDs emit light at a different wavelength than the second group of LEDs and wherein the first group of LEDs are capable of emitting light at a wavelength of about 660 nm and wherein the second group of LEDs are capable of emitting light at a wavelength of about 440 nm.

18. A portable massage, magnet and light therapy device comprising:
a body portion;
a head portion that is attachable to an end of the body portion;
a plurality of magnets mounted to at least one of the body portion and the head portion;
a plurality of LEDs mounted to at least one of the body portion and the head portion, wherein the plurality of LEDs comprises a first group of LEDs and a second group of LEDs, wherein the first group of LEDs emit light at a different wavelength than the second group of LEDs;
a vibrating mechanism mounted to at least one of the body portion and the head portion; and
a power mechanism that is operably attached to the plurality of LEDs and the vibrating mechanism.

19. The portable massage, magnet and light therapy device of claim 18, wherein the head portion is removably attached to the body portion with a thread mechanism, wherein the portable massage, magnet and wherein the light therapy device further comprises a resilient cover that extends over at least a portion of the body portion.

20. The portable massage, magnet and light therapy device of claim 18, wherein the first group of LEDs are capable of emitting light at a wavelength of about 660 nm and wherein the second group of LEDs are capable of emitting light at a wavelength of about 440 nm.
